(19) United States
(12) Patent Application Publication
(10) Pub. No.: US 2015/0100758 A1
(43) Pub. Date: Apr. 9, 2015

(54) DATA PROCESSOR AND METHOD OF LANE REALIGNMENT

(71) Applicant: ADVANCED MICRO DEVICES, INC., Sunnyvale, CA (US)

(72) Inventors: Timothy G. Rogers, Redmond, WA (US); Bradford M. Beckmann, Redmond, WA (US); James M. O'Connor, Austin, TX (US)

(73) Assignee: ADVANCED MICRO DEVICES, INC., Sunnyvale, CA (US)

(21) Appl. No.: 14/045,114

(22) Filed: Oct. 3, 2013

(51) Int. Cl. G06F 9/38

(52) U.S. Cl. CPC G06F 9/3887
USPC 712/22

(57) ABSTRACT

A data processor includes a register file divided into at least a first portion and a second portion for storing data. A single instruction, multiple data (SIMD) unit is also divided into at least a first lane and a second lane. The first and second lanes of the SIMD unit correspond respectively to the first and second portions of the register file. Furthermore, each lane of the SIMD unit is capable of data processing. The data processor also includes a realignment element in communication with the register file and the SIMD unit. The realignment element is configured to selectively realign conveyance of data between the first portion of the register file and the first lane of the SIMD unit to the second lane of the SIMD unit.

### TECHNICAL FIELD

The technical field relates generally to a data processor and particularly to a graphics processing unit (GPU) and methods for improving performance thereof.

### BACKGROUND

Graphics processing units (GPUs) have typically been utilized to build images, such as 3-D graphics, for a display. More recently, these GPUs have been utilized in more general-purpose applications in which a conventional central processing unit (CPU) is typically utilized. These GPUs may utilize single-instruction, multiple-data (SIMD) hardware to perform a plurality of calculations in parallel with one another.

Unfortunately, SIMD hardware is often negatively impacted by single-instruction, multiple-thread (SIMT) code that includes threads whose control flows diverge. When such divergence occurs, some lanes of the SIMD hardware are masked off and not utilized. Thus, SIMD hardware efficiency is reduced, as the hardware is not operated at its maximum throughput.

Software modification has been utilized in an attempt to manage such inefficiencies in SIMD hardware utilization. However, such modifications are time-consuming for software programmers and developers who must consider thread divergence issues in the context of specific hardware.

### BRIEF SUMMARY OF EMBODIMENTS

In one embodiment, a data processor is provided that includes, but is not limited to a register file comprising at least a first portion and a second portion for storing data. A single instruction, multiple data (SIMD) unit comprises at least a first lane and a second lane. The first lane and the second lane of the SIMD unit correspond respectively to the first and second portions of the register file. Furthermore, each lane of the SIMD unit is capable of data processing. The data processor also includes, but is not limited to a realignment element in communication with the register file and the SIMD unit. The realignment element is configured to selectively realign conveyance of data between the first portion of the register file and the first lane of the SIMD unit to the second lane of the SIMD unit.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram illustrating a data processor according to some embodiments;

FIG. 2 is a block diagram illustrating the data processor including a register file cache according to some embodiments;

FIG. 3 is a block diagram illustrating a register segment identifier stack of the register file cache according to some embodiments;

FIG. 4 is a graph illustrating performance of the data processor in comparison to the prior art; and

FIG. 5 is a graph illustrating normalized improvement of the data processor compared to the prior art.

### DETAILED DESCRIPTION

The following detailed description is merely exemplary in nature and is not intended to limit application and uses. Embodiments described herein are not necessarily to be construed as advantageous over other embodiments. Embodiments described herein are provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, and the following detailed description or for any particular computing system.

In this document, relational terms such as first and second, and the like may be used solely to distinguish one entity or action from another entity or action without necessarily requiring or implying any actual such relationship or order between such entities or actions. Numerical ordinals such as first, second, third, etc., simply denote different singles of a plurality and do not imply any order or sequence unless specifically defined by the claim language.

Finally, for the sake of brevity, conventional techniques and components related to computing systems and other functional aspects of a computing system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in the embodiments disclosed herein.

Referring to the figures, wherein like numerals indicate like parts throughout the several views, a data processor 100 and methods are shown and described herein.

The data processor 100 is commonly referred to as a graphics processing unit (GPU) or a general-purpose graphics processing unit (GPGPU). However, the data processor 100 described herein should not be limited to GPU or GPGPU labeling. Furthermore, those skilled in the art realize that GPUs may be utilized for more than the processing of graphics. The data processor 100 includes a plurality of transistors (not shown) and other electronic circuits to perform storage and calculations as is well known to those skilled in the art. The data processor 100 may further include other functional units or cores (not shown), including, but not limited to, a CPU core.

The data processor 100 includes a single instruction, multiple data (SIMD) unit 102. As is appreciated by those skilled in the art, the SIMD unit 102 is capable of synchronously executing an instruction on a plurality of data elements. As such, the SIMD unit 102 includes a plurality of lanes 104A, 104B, 104C. The SIMD unit 102 includes at least a first lane 104A and a second lane 140B. However, the SIMD unit 102 may include any number of lanes and is certainly not limited to the first lane 104A and the second lanes 104B. For instance, the SIMD unit 102 further includes a third lane 104C. While the first lane 104A, second lane 104B, and third lane 104C, are shown as being consecutive and adjacent one another in the figures, it should be appreciated that these lanes 104A, 104B, 104C may be non-consecutive and that other lanes (not shown) may be disposed there between.

Each lane 104A, 104B, 104C of the SIMD unit 102 may receive data that is processed in accordance with an instruction. Those skilled in the art realize that the data acted upon simultaneously by the lanes 104A, 104B, 104C of the SIMD unit 102 may be referred to as threads or work items. These threads may be grouped into wavefronts or warps. Each wavefront or warp includes multiple threads that are executed synchronously. Furthermore, multiple wavefronts or warps may be grouped together as part of a workgroup or a thread block.

The data processor 100 also includes a register file 106 for storing data. The register file 106 may comprise an array of processor registers as is well known to those skilled in the art. The register file 106 may include a plurality of portions 108A, 108B, and 108C. Specifically, the register file 106 includes at least a first portion 108A and a second portion 108B. However, the register file 106 may include any number of portions and is certainly not limited to the first portion 108A and the second portion 108B. For instance, the register file 106 further includes a third portion 108C. While the first, second, and third portions 108A, 108B, 108C are shown as being consecutive and adjacent one another in the figures, it should be appreciated that these portions 108A, 108B, 108C may be non-consecutive and that other portions (not shown) may be disposed there between.

Each portion 108A, 108B, 108C is configured to store at least one thread of data. The portions 108A, 108B, 108C of the register file 106 correspond respectively to the lanes 104A, 104B, 108C of the SIMD unit 102. That is, the first portion 108A of the register file 106 corresponds to the first lane 104A of the SIMD unit 102, the second portion 108B of the register file 106 corresponds to the second lane 104B of the SIMD unit 102, and the third portion 108C of the register file 106 corresponds to the third lane 104C of the SIMD unit 102. These threads of data may be transferred, copied, or otherwise transmitted to the SIMD unit 102 for processing as further described below.

The data processor 100 further includes a realignment element 110 in communication with the register file 106. More specifically, the realignment element 110 is logically in communication with the register file 106 such that data may be transferred back-and-forth between the register file 106 and the realignment element 110. However, in some embodiments, the data may be transferred in only one direction, e.g., from the register file 106 to the realignment element 110.

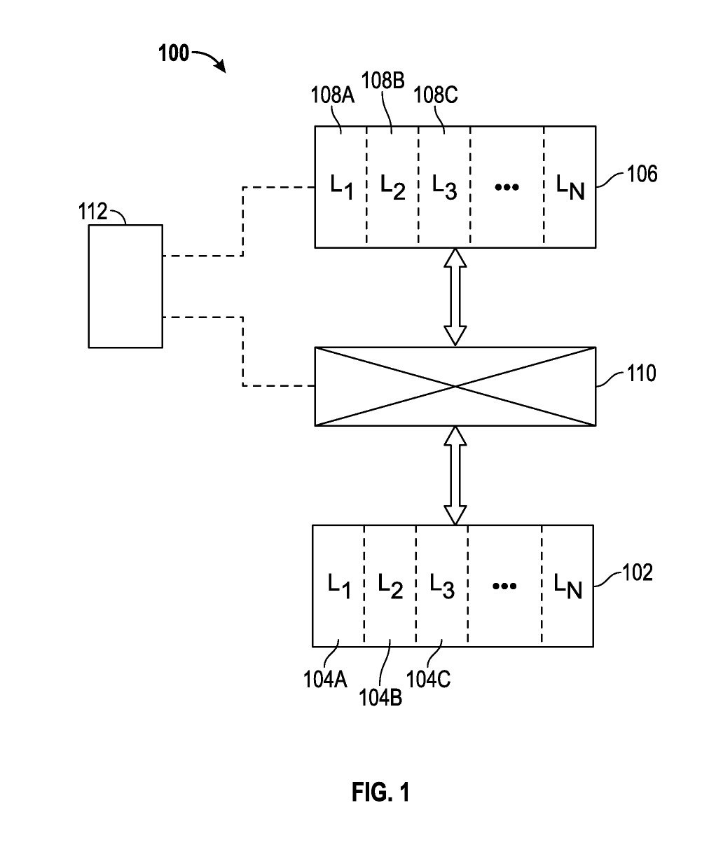

In some embodiments, such as shown in FIG. 1, the realignment element 110 is also in communication with the SIMD unit 102. More specifically, in some embodiments, the realignment element 110 is logically in communication with to the SIMD unit 102 such that data may be transferred back-and-forth between the realignment element 110 and the SIMD unit 102. However, in some embodiments, the data may be transferred in only one direction, e.g., from the realignment element 110 to the SIMD unit 102.

The realignment element 110 is configured to selectively realign conveyance of data between at least one portion 108A, 108B, 108C of the register file 106 and at least one lane 104A, 104B, 104C of the SIMD unit 102. For instance, a data thread travelling from the first portion 108A of the register file 106 may be normally aligned with the first lane 104A of the SIMD unit 102, such that data flows between the respective first portion 108A and first lane 104A. However, the realignment element 110 may realign or alter the conveyance of data from the first portion 108A of the register file 106 to the second lane 104B of the SIMD unit 102.

The realignment element 110 may further be configured to selectively realign conveyance of data between any of the portions 108A, 108B, 108C of the register file 106 to any of the lanes 104A, 104B, and 104C of the SIMD unit 102. For example, the realignment element 110 may be configured to transfer a thread of data from the second portion 108B of the register file 106 to the first lane 104A of the SIMD unit 102 during one wavefront and then configured to transfer a thread of data from the second portion 108B of the register file 106 to the third lane 104C of the SIMD unit 102 during another wavefront.

With the ability to realign data transmission between register file 106 portions 108A, 108B, 108C to/from the SIMD unit 102 lanes 104A, 104B, 104C, the data processor 100 is able to make use of the processing ability of non-utilized or underutilized lanes 104A, 140B, 104C of the SIMD unit 102. This allows increased performance of the data processor 100.

The data processor 100 further includes a realignment controller 112. The realignment controller 112 is configured to determine if data stored in the portions 108A, 108B, 108C of the register file 106 should be realigned by the realignment element 110. For instance, the realignment controller 112 may determine if data stored in the first portion 108A of the register file 106 should be realigned to be processed in the second lane 104B of the SIMD unit 102.

The realignment controller 112 is in communication with the realignment element 110. Furthermore, the realignment controller 112 is configured to send a command to the realignment element 110 in response to the realignment controller 112 determining that data stored in the portions 108A, 108B, 108C of the register file 106 should be realigned by the realignment element 110. For instance, the realignment controller 112 may be configured to send a command to the realignment element 110 in response to realignment controller 112 determining that data stored in the first portion 108A of the register file 106 should be realigned to be processed in the second lane 104B of the SIMD unit 102.

In some embodiments, the realignment controller 112 may be in communication with the register file 106 for receiving information about the portion 108A, 108B, 108C assignments of data threads that are stored the register file 106 to assist in determining if realignment of data should occur. Furthermore, other regions of the data processor 100 may also be in communication with the realignment controller 112 to assist in the realignment determination.

A variety of criteria may be analyzed in determining if realignment by the realignment element 110 should occur and which portions 108A, 108B, 108C and lanes 104A, 104B, 104C should be realigned. For instance, a level of branch divergence may be analyzed by the realignment controller 112. Those skilled in the art appreciate that branch divergence occurs when data threads inside wavefronts (or warps) are assigned different portions 108A, 108B, 108C, which results in some SIMD unit 102 lanes 104A, 104B, 104C not being utilized in a particular wavefront. For example, if a threshold number of the SIMD unit 102 lanes 104A, 104B, 104C are not being utilized, then the realignment controller 112 may command the realignment element 110 to realign the data threads. The threshold number of SIMD unit 102 lanes 104A, 104B, 104C may be dynamically determined based on various considerations regarding the performance of processor 100 and the system as a whole in which processor 100 resides.

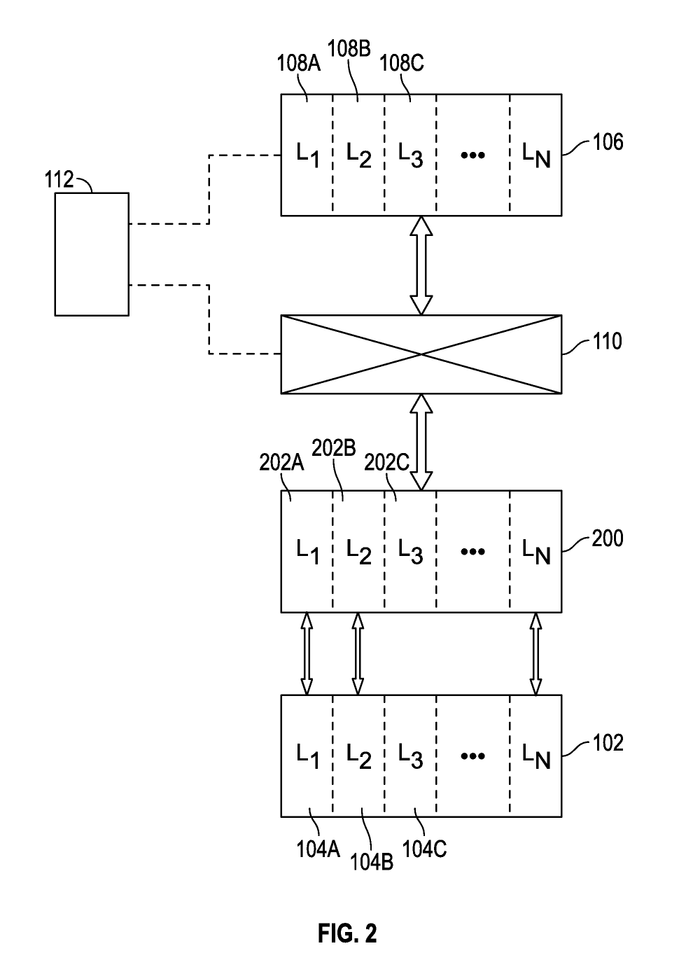

In some embodiments, the data processor 100, as shown in FIG. 2, further includes a register file cache 200 for temporarily storing data. Similar to the register file 106, the register file cache 200 includes a plurality of segments 202A, 202B, 202C. Specifically, the register file cache 200 comprises at least a first segment 202A and a second segment 202B. However, the register file cache 200 may include any number of segments and is certainly not limited to the first and second segments 202A, 202B. For instance, the register file cache 200 may further includes a third segment 202C. While the first, second, and third segments 202A, 202B, 202C are shown as being consecutive and adjacent one another in the figures, it should be appreciated that these segments 202A, 202B, 202C may be non-consecutive and that other segments (not shown) may be disposed therebetween.

Each segment 202A, 202B, 202C is configured to store at least one thread of data. The segments 202A, 202B, 202C of the register file cache 200 correspond respectively to the lanes 104A, 104B, 104C of the SIMD unit 102. That is, the first segment 202A of the register file cache 200 corresponds to the first lane 104A of the SIMD unit 102, the second segment 202B of the register file cache 200 corresponds to the second lane 104B of the SIMD unit 102, and the third segment 202C of the register file cache 200 corresponds to the third lane 104C of the SIMD unit 102. Accordingly, the segments 202A, 202B, 202C of the register file cache 200 also correspond respectively to the portions 108A, 108B, 108C of the register file 106.

The register file cache 200 is disposed between, and in communication with, the realignment element 110 and the SIMD unit 102. Described in another manner, in some embodiments, the realignment element 110 is not in direct communication with the SIMD unit 102. Rather, in the some embodiment, data passes through the register file cache 200 when being transferred to/from the SIMD unit 102.

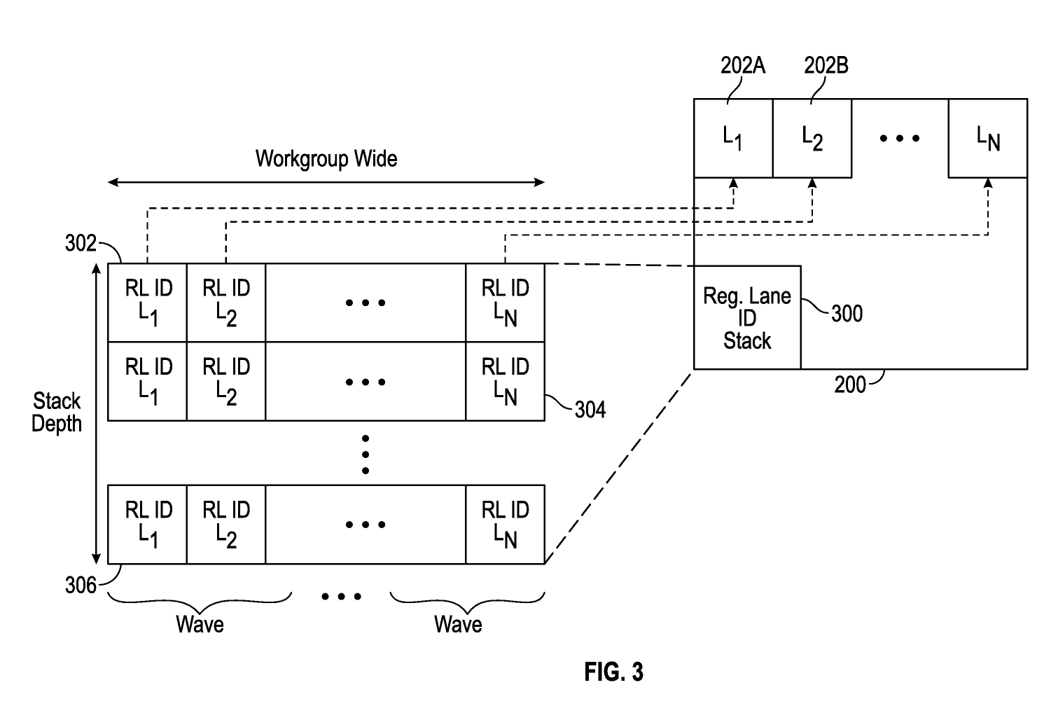

The register file cache 200 may also be utilized to remap work items to the particular lanes of the SIMD unit 102. For instance, the work items may be re-arranged to maximize the number of work items in each wavefront that are executing the same instruction. A more detailed schematic illustration of the register file cache 200, according to some embodiments, such as shown in FIG. 3. The register file cache 200 illustrated in FIG. 3 includes a register segment identifier stack 300. The register segment identifier stack 300 includes a plurality of stack levels represented by a first stack level 302, a second stack level 304, and an n^{th} stack level 306. Each stack level 302, 304, 306 of the register segment identifier stack 300 includes a plurality of register segment identifiers represented by a first segment identifier (not numbered) and a second segment identifier (not numbered). Each segment identifier references a respective segment 202A, 202B of the register file cache 200. The register segment identifiers of the register segment identifier stack 300 are re-arranged at each stack level. Accordingly, work items that follow a similar work flow path through the code may be executed on contiguous physical lanes, thus improving SIMD efficiency. One example of a register file cache 200 and methods are further described in U.S. patent application Ser. No. 13/689,421, filed on Nov. 29, 2012, which is hereby incorporated by reference.

By utilizing the register file cache 200, the data processor 100 may more fully utilize the lanes 104A, 104B, 104C of the SIMD unit 102. For example, in some workgroups, data threads are stored in the register file 106 in every other portion, e.g., the first and third portions 108A, 108C and so on. By utilizing the realignment element 110 acting in concert with the register file cache 200, every other wavefront of threads could be realigned.

For example, in a first wavefront, data from the first portion 108A of the register file 106 would be transferred to the first segment 202A of the register file cache 200, while in a second wavefront, data from the first portion 108A of the register file 106 would be realigned into the second segment 202B of the register file cache 200. The segments of the register file cache 200 would then be full and transferred to the SIMD unit 102 for processing. Thus, the SIMD unit 102 provides improved utilization of its lanes 104A, 104B, 104C. After processing, the data threads may be transferred back to the register file cache 200, selectively realigned, then transferred back to the register file 106.

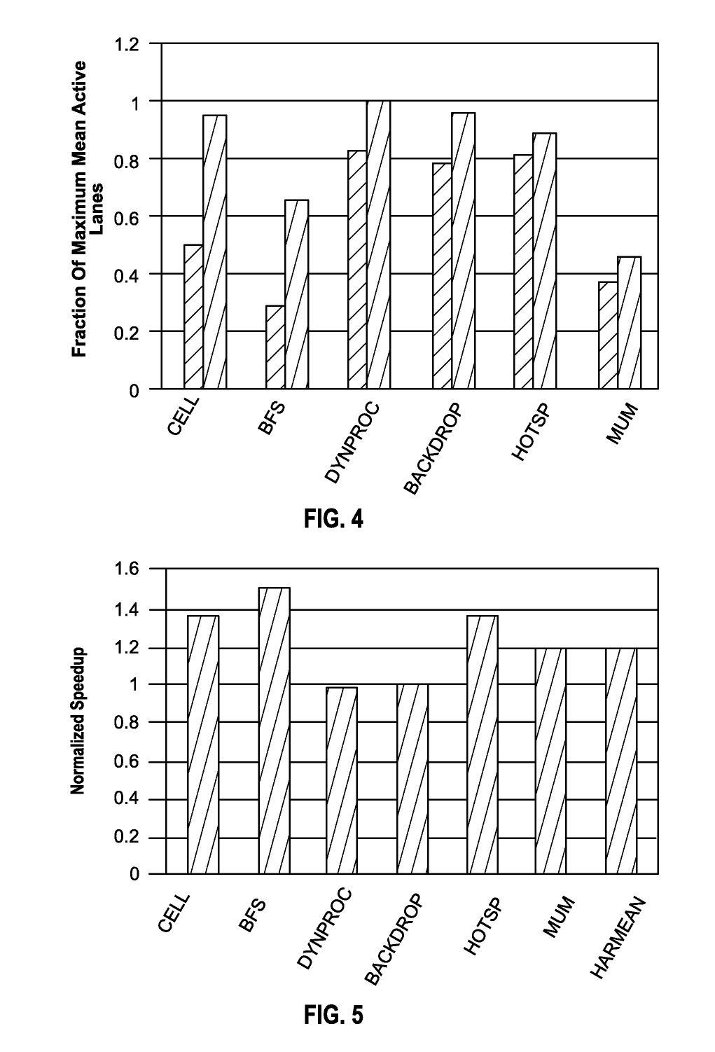

FIGS. 4 and 5 illustrate the performance improvement that may be realized when utilizing a data processor 100 of the type shown in FIG. 2 in some situations. Specifically, FIG. 4 presents two columns (a left column and a right column) associated with various processes. The left columns illustrate the fraction of maximum mean active lanes for each process run on a prior art GPU, while the right columns illustrate the same fraction run on the data processor 100. FIG. 5 illustrates the normalized speedup of each processes run on the data processor 100 in comparison to the prior art GPU.

Although the above description concentrates primarily on data being transferred from the register file 106 to the SIMD unit 102, the data processor 100 is also configured such that data may be transferred from the SIMD unit 102 back to the register file 106. The realignment element 110 may be configured to realign data flowing back to the register file 106. For instance, the realignment element 110 may realign the data flowing back to the register file 106 into the same patterns and/or configurations as data originally flowing from the register file 106.

A data structure representative of the data processor 100 and/or portions thereof included on a computer readable storage medium may be a database or other data structure which can be read by a program and used, directly or indirectly, to fabricate the hardware comprising data processor 100. For example, the data structure may be a behavioral-level description or register-transfer level (RTL) description of the hardware functionality in a hardware description language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the data processor 100. The netlist may then be placed and routed to produce a data set describing geometric shapes to be applied to masks. The masks may then be used in various semiconductor fabrication steps to produce a semiconductor circuit or circuits corresponding to the data processor 100. Alternatively, the database on the computer readable storage medium may be the netlist (with or without the synthesis library) or the data set, as desired, or Graphic Data System (GDS) II data.

The operation of the data processor 100 described herein may be governed by instructions that are stored in a non-transitory computer readable storage medium and that are executed by a computing system. Each of the operations may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A data processor comprising:
a realignment element in communication with a register file having first and second portions and a single instruction, multiple data (SIMD) unit having at least first and second lanes corresponding to said first and second portions of the register file, the realignment element configured to selectively realign conveyance of data between the first portion of the register file and the first lane of the SIMD unit to the second lane of the SIMD unit.

2. A data processor as set forth in claim 1 further comprising a register file cache in communication with the SIMD unit and comprising at least a first segment and a second segment, the first segment and the second segment of the register file cache corresponding respectively to the first lane and the second lane of the register file.

3. A data processor as set forth in claim 2 wherein the realignment element is in communication with the register file and the register file cache, the realignment element configured to selectively realign conveyance of data between the first portion of the register file and the first segment of the register file cache to the second segment of the register file cache.

4. A data processor as set forth in claim 3 wherein the register file cache includes a register segment identifier stack.

5. A data processor as set forth in claim 1 further comprising a realignment controller for determining if data stored in the first portion of the register file should be realigned to be processed in the second lane of the SIMD unit.

6. A data processor as set forth in claim 5 wherein the realignment controller is in communication with the realignment element and wherein the realignment controller is configured to send a command to the realignment element in response to the realignment controller determining that data stored in the first portion of the register file should be realigned to be processed in the second lane of the SIMD unit.

7. A data processor as set forth in claim 6 wherein the register portion identifier stack includes a plurality of stack levels.

8. A data processor as set forth in claim 4 wherein the realignment controller is in communication with the register file for receiving information about portion assignments of data stored in the register file.

9. A data processor as set forth in claim 1 further comprising
the register file; and
the SIMD unit, wherein the SIMD unit is capable of data processing.

10. A method of operating a data processor, the data processor including a register file comprising at least a first portion and a second portion for storing data and further including a single instruction, multiple data (SIMD) unit comprising at least a first lane and a second lane, the first and the second lane of the SIMD unit corresponding respectively to the first and the second portion of the register file, the method comprising:
selectively realigning conveyance of data between the first portion of the register file and the first lane of the SIMD unit to the second lane of the SIMD unit.

11. A method as set forth in claim 10 further comprising receiving information about portion assignments of data stored in the register file.

12. A method as set forth in claim 11 further comprising determining if data stored in the first portion of the register file should be realigned to be processed in the second lane of the SIMD unit.

13. A method as set forth in claim 12 wherein the selectively realigning conveyance of data is performed in response to determining that the data stored in the first portion of the register file should be realigned to be processed in the second lane of the SIMD unit.

14. A method as set forth in claim 10 wherein the data processor further includes a register file cache in communication with the SIMD unit and comprising at least a first segment and a second segment, the first segment and the second segment of the register file cache corresponding respectively to the first portion and the second portion of the register file, the method further comprising a second selectively realigning conveyance of data between the first portion of the register file and the first segment of the register file cache to the second segment of the register file cache.

15. A method as set forth in claim 14 further comprising rearranging work items in the register file cache to maximize the number of work items in each wavefront that are executing the same instruction.

16. A non-transitory computer readable media storing instructions that, when processed, are adapted to configure a manufacturing facility to manufacture a data processor comprising a realignment element in communication with a register file having first and second portions and a SIMD unit having at least first and second lanes corresponding to said first and second portions of the register file, the realignment element configured to selectively realign conveyance of data between the first portion of the register file and the first lane of the SIMD unit to the second lane of the SIMD unit.

17. A non-transitory computer readable media as set forth in claim 16 wherein the instructions are formatted in a hardware description language.

18. A non-transitory computer readable media as set forth in claim 16 wherein the data processor further comprises a register file cache in communication with the SIMD unit and comprising at least a first segment and a second segment, the first segment and the second segment of the register file cache corresponding respectively to the first lane and the second lane of the register file.

19. A non-transitory computer readable media as set forth in claim 18 wherein the realignment element is in communication with the register file and the register file cache, the realignment element configured to selectively realign conveyance of data between the first portion of the register file and the first segment of the register file cache to the second segment of the register file cache.
